(19) United States
(12) Patent Application Publication
(10) Pub. No.: US 2020/0371902 A1
(43) Pub. Date: Nov. 26, 2020

(54) SYSTEMS AND METHODS FOR SOFTWARE REGRESSION DETECTION

(71) Applicant: ServiceNow, Inc., Santa Clara, CA (US)

(72) Inventors: Carmine Mangione-Tran, San Diego, CA (US); Raman Kathuria, Santa Clara, CA (US)

(21) Appl. No.: 16/508,097

(22) Filed: Jul. 10, 2019

Related U.S. Application Data
(60) Provisional application No. 62/850,965, filed on May 21, 2019.

(51) Int. Cl. G06F 11/36; G06N 20/00

(52) U.S. Cl. CPC G06F 11/3688; G06N 20/00; G06F 11/3692

(57) ABSTRACT

The disclosed Test Case Prioritization (TCP) system includes a TCP server that is designed to generate a TCP Model, which stores identified relationships between software files and test cases based on test results. The TCP server groups the test cases by track and/or build, and clusters the test cases that correspond to failed test results within each group. The TCP server also determines which software files have been modified since a previous testing of the software files. The TCP server then correlates the clusters of test cases and the modified software files to construct the TCP model. Once the TCP model has been generated, the TCP server can use the TCP model to provide useful information during software development and testing.

### CROSS REFERENCE TO RELATED APPLICATIONS

This application claims priority from and the benefit of U.S. Provisional Application No. 62/850,965, entitled “SYSTEMS AND METHODS FOR SOFTWARE REGRESSION DETECTION,” filed May 21, 2019, which is incorporated by reference herein in their entirety for all purposes.

### BACKGROUND

The present disclosure relates generally to software development. More specifically, the present disclosure relates to detecting and reducing regressions during software development.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, load balancers, firewalls, switches, etc.) and software resources (e.g. productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

Additionally, certain cloud-computing platforms enable software development. For example, a cloud-computing platform may host software development tools that enable developers to create, modify, and test software files. The software development tools may include a build system that stores multiple versions of various software files throughout the development process. The build system may be designed to provide isolated sets of software files, referred to as tracks, which enables particular groups of software developers to cooperatively modify their respective branch of a large software development project without interfering with one another. Once development of a track is completed, then the track can be merged with other tracks into a master version (e.g., production or release version) of the software. As such, a particular build of the software can represent a particular set of software modifications across multiple tracks during software development.

At various points during software development, portions of the software may be tested to ensure that regressions have not been introduced when modifying previously developed software code. As used herein, the term “regression” refers to an unintended loss and/or undesired change in functionality of a piece of software (e.g., a software file) relative to a previous version. For example, a feature may be developed in a previous version of a software file and defined to operate according to some criteria, and a regression is introduced when a modification of the software file results in the feature no longer operating in accordance with this criteria. Software testing is usually performed using test cases, which test software features based on their defined criteria in order to identify regressions. A test case generally includes a defined set of inputs (e.g., integers, strings, records, simulated mouse clicks, and so forth) and a defined set of expected outputs (e.g., integers, strings, records). As such, to test a piece of software, the software is executed using the defined set of inputs, and a set of outputs are returned and compared to the set of expected outputs. A test case yields a successful test result when the returned outputs match the expected outputs, and a yields a failure when the returned outputs match the expected outputs do not match or exception is encountered during execution.

However, there may be a multitude of test cases that are used to test certain pieces of software, such as thousands to hundreds of thousands of test cases, and large software development projects may include thousands to hundreds of thousands of software files. The volume of test cases and software files can result in substantial consumption of processor resources and development delay. Additionally, the substantial volume of test results generated by applying these test cases can require substantial developer time to review. Moreover, certain test cases, referred to herein as “flappers,” may randomly provide false successes or false failures that are not associated with an actual regression. As such, flappers can prevent developers from accurately and efficiently identifying actual regressions during software development and testing.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present approach relates generally to a Test Case Prioritization (TCP) System that improves the efficiency of software testing and provides software developers with additional insight regarding potential regressions introduced during software development. The TCP system includes a TCP server that is designed to generate a TCP Model that stores identified relationships between software files and test cases based on test results. For example, in an embodiment, to test of a set of software files, the software files may be executed according to a set of test cases, and the corresponding test results may be stored. Subsequently, the TCP server groups the test cases by track and/or build, and clusters the test cases that correspond to failed test results within each group. The TCP server also determines which software files have been modified since a previous testing of the software files. The TCP server then correlates the clusters of test cases and the modified software files to construct the TCP model.

Once the TCP model has been generated, the TCP server can use the TCP model to provide useful information during software development and testing. For example, the TCP server can provide a set of software files to be tested as an input to the TCP model, and the TCP model may return a minimum set of test cases that should be successfully passed to provide a reasonable likelihood that regressions have not been introduced when the software files were modified, as well as provide a confidence level value indicating a confidence that successfully passing the test cases is indicative of an absence of regressions in the set of software files. In another example, the TCP server may provide one or more failed test results as an input to the TCP model, and the TCP model may return likelihoods or probabilities that each of the failed test results are the result of regressions or flappers.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud architecture in which embodiments of the present disclosure may operate;

FIG. 2 is a schematic diagram of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating an embodiment in which a Test Case Prioritization (TCP) system includes a TCP server hosted as part of a client instance on the cloud architecture, in accordance with aspects of the present disclosure;

FIG. 5 is a diagram illustrating an embodiment of a data model that is associated with the TCP system of FIG. 4, in accordance with aspects of the present disclosure;

FIG. 6 is a flow diagram illustrating an embodiment of a process whereby the TCP server generates a TCP model, in accordance with aspects of the present disclosure;

FIG. 7 is a flow diagram illustrating an example embodiment of a process whereby the TCP server uses the TCP model to determine a minimum set of test cases that would provide a minimal assessment of whether or not a regression has been introduced in one or more software files modified since previous software testing occurred, in accordance with aspects of the present disclosure;

FIG. 8 is a flow diagram illustrating an example embodiment of a process whereby the TCP server determines a probability or a likelihood that a test case is a flapper, in accordance with aspects of the present disclosure; and

FIG. 9 is a flow diagram illustrating an example embodiment of a process whereby the TCP server uses the TCP model to determine a likelihood or probability that a planned software modification will introduce a regression, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “test cases” refers to one or more tests that may be provided as an input to a software file to determine whether or not a software file functioning as intended. For example, a test case may define a set of input values and an expected set output values that correspond with a feature of the software. A “success” when executing a software file according to a test case is receiving the expected set of output values, and a “failure” is receiving a null, an exception, or a different set output values other than the expected set of output values. As used herein, the term “flappers” refers to test cases that produce failure and success results regardless of whether or not the software file actually has a regression, and, therefore, correspond to false positive/negative test results. As used herein, the term “software file” may refer to files containing instructions that are executed by a computer processor, including files with interpreted instructions, partially compiled instructions, or fully compiled instructions. As used herein, the terms “preflight check” and “preflight verification” refer to a test performed on one or more software files during software development to evaluate potential errors or regressions, such as prior to the software files being merged with a master (e.g., production or release) version of the software.

As software files are developed, certain portions of the software files may be modified, which may result in regressions when executing the software file. In general, regressions in software files are detected based on a test result (e.g., success or failure) when the software files are executed according to one or more test cases. While certain test cases may be better suited for identifying regressions in certain changed software files, identifying suitable test cases for the modified software files may be difficult as a test case database may store a large number (e.g., ten thousand to hundreds of thousands) of test cases. Moreover, certain test cases are flappers that yield false successes or false failures, and thus, prevent developers from accurately and efficiently identifying actual regressions.

The present approach is generally directed to a Test Case Prioritization (TCP) system that is capable of generating and applying a TCP model to improve the efficiency and effectiveness of software testing. The disclosed TCP model stores correlations between modified software files and clusters of test cases. Once generated, the disclosed TCP system can apply the TCP model to reduce the number of test cases involved in a preflight verification and to facilitate accurate and efficient identification of regressions and flappers. As one non-limiting example, based on one or more test failures, and the TCP model may be used to determine which software files are likely responsible for the test failure. As another non-limiting example, the TCP model may be used to determine a probability or likelihood that a regression has been introduced when a software file was modified. As a further non-limiting example, based on set of modified software files, the TCP model may be used to determine a minimum set of test cases that, if successfully passed, provides a high probability of no regressions have been introduced when the software files were modified.

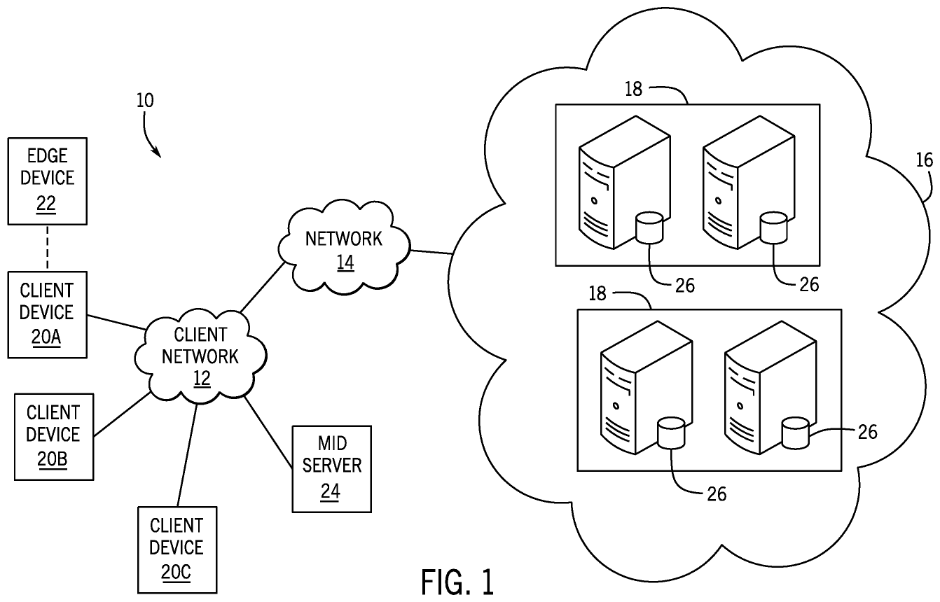

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device or server, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 14. The network 14 may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

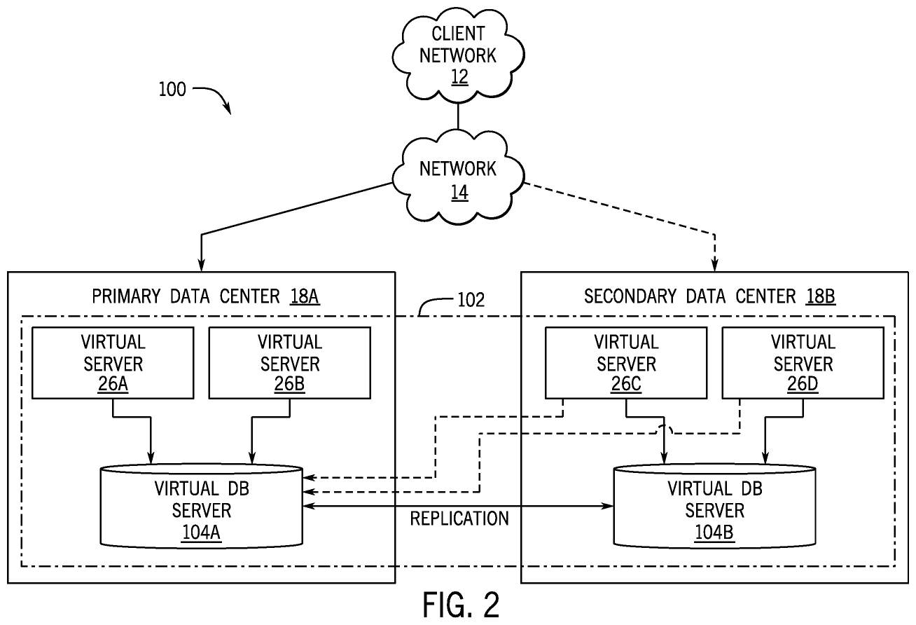

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

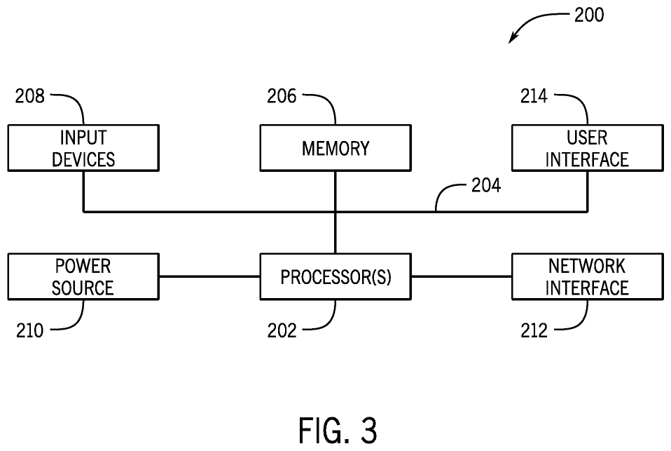

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing system 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

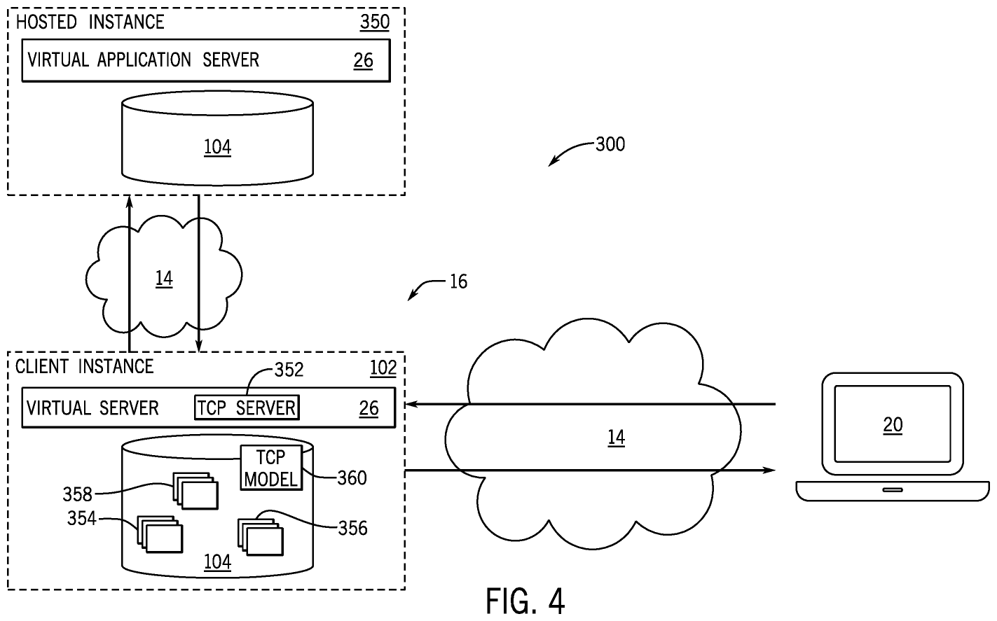

With the foregoing in mind, FIG. 4 is a block diagram illustrating an embodiment of a Test Case Prioritization (TCP) system 300 hosted by the virtual server 26 of the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser of the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with client instance 102 using an application that is executed within a web browser. The client instance 102 may also be configured to communicate with other instances, such as the hosted instance 350 shown in FIG. 4, which may also include a virtual application server 26 and a virtual database server 104. In certain embodiments, one or more portions of the TCP system 300 may be hosted by the virtual application server 26 and/or the virtual database server 104 of the hosted instance 350, which may be referred to as a developer instance.

As illustrated, the database server 104 of the client instance 102 is configured to store software files 354, test cases 356, and test results 358 that are utilized by the TCP server 352 to generate a TCP model 360, which is also stored by the database server 104. Additionally, the illustrated embodiment of the TCP system 300 includes a TCP server 352. The TCP server 352 is an application that includes instructions executable by one or more processors associated with the virtual server 26 to generate and apply the TCP model 360, as discussed herein. In certain embodiments, the TCP server 352 and the TCP model 360 may be part of a software build system of the client instance 102.

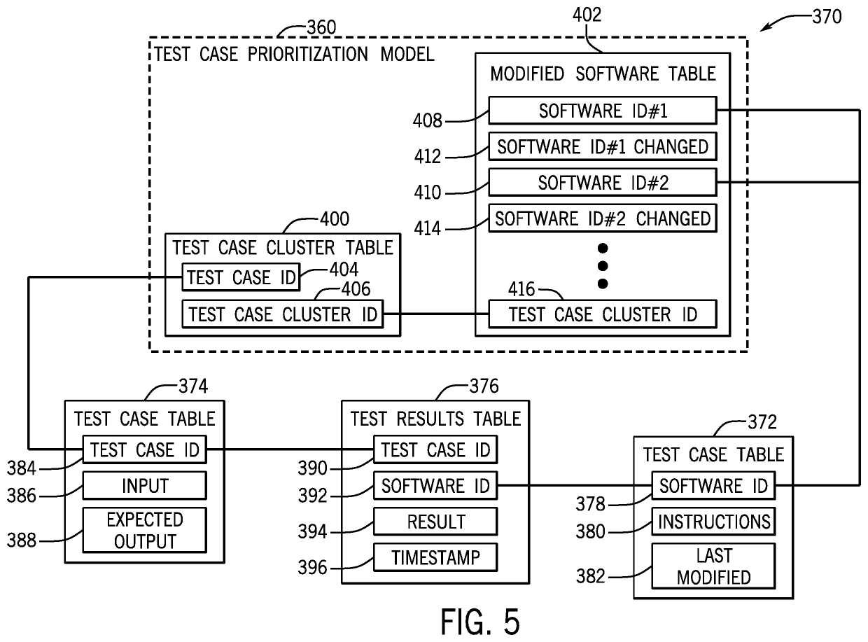

FIG. 5 is a diagram illustrating an embodiment of a data model 370 that is associated with the TCP system 300 of FIG. 4. The data model 370 may be stored in by the database server 104 as a collection of interrelated tables or classes. For the embodiment illustrated in FIG. 5, the data model 370 includes a software file table 372 that is designed to store the software files 354, a test case table 374 that is designed to store the test cases 356, and a test results table 376 that is designed to store the test results 358, as mentioned above. It may be appreciated that the illustrated data model 370 is intended to be illustrative, and in other embodiments, the data model 370 may include additional or fewer fields, additional or fewer tables, additional or fewer relationships, and so forth, in accordance with the present disclosure.

More specifically, for the illustrated embodiment, the software table 372 includes a software identifier (ID) field 378 that is designed to store a unique identifier (e.g., a primary key) for a software file. In certain embodiments, the software ID field 378 includes information about the track, build, and/or version (e.g., a Track ID, a Build ID, Version ID) of a particular software file. The software table 372 includes an instructions field 380 that is designed to store the instructions (e.g., software code, interpreted instruction, compiled instructions) associated with each software file. For the illustrated embodiment, the software table 372 also includes a last modified field 382 that stores a timestamp indicating when the software file was last modified.

For the illustrated embodiment, the test case table 374 includes a test case identifier (ID) field 384 that is designed to store a unique identifier (e.g., a primary key) for a test case. The test case table 374 includes an input field 386 that is designed to store inputs (e.g., parameter values) that are provided to a software file being tested, as well as an expected output field 388 that is designed to store expected output values (e.g., return values) when the software file is executed. In other embodiments, the test case table 374 may include fields that include a name or textual description of the software feature being tested by the test case, a time and date that the test case was created, an author of the test case, and so forth.

For the illustrated embodiment, the test results table 376 includes a test case ID field 390 and a software ID field 392. The test case ID field 384 of the test case table 374 has a one-to-many relationship with the test case ID field 390 of the test results table 376, and the software ID field 378 of the software table 372 has a one-to-many relationship with the software ID field 392 of the test results table 376. The test results table 376 also includes a result field 394 that is designed to store a Boolean value indicating whether the each test result is a success or a failure. For the illustrated embodiment, the test results table 376 also includes a timestamp field 396 indicating when the test result was generated. It may be appreciated that the test results table 376 stores test results from previous software testing of previous versions of the software files.

It is presently recognized that logical correlations can be established between the software files 354, the test cases 356, and the test results 358. For example, it is presently recognized that it is advantageous to group or cluster together certain test cases that tend to fail together when software files are executed according to the test cases. It is also presently recognized that it is advantageous to correlate these clusters of test cases with software files that were modified since a previous round of software testing.

With the foregoing in mind, the data model 370 illustrated in FIG. 5 includes the TCP model 360, which generally stores correlations between clusters of test cases and software files modified since a previous round of software testing. For the illustrated embodiment, the TCP model 360 includes a test case cluster table 400 and a modified software table 402 that are related to one another, and are related to the test case table 374 and the software table 372, respectively. The test case cluster table 400 includes a test case ID field 404, wherein the test case ID field 384 of the test case table 374 has a one-to-many relationship with the test case ID field 404 of the test case cluster table 400. The test case cluster table 400 also includes a test case cluster identifier (ID) field 406 designed to store a value (e.g., an integer) indicating a cluster to which the test case is assigned, as discussed below. As such, it may be appreciated that each test case in the test case table 374 may be associated with multiple entries, and therefore multiple clusters, in the test case cluster table 400.

The modified software table 402 of the TCP model 360 includes a number of software ID fields (e.g., software ID#1 field 408, software ID #2 field 410) that are designed to store software ID values, wherein each of these fields has a respective one-to-one relationship with the software ID field 378 of the software table 372. The modified software table 402 also includes a respective software changed field (e.g., software ID#1 changed field 412, software ID#2 changed field 414) for each software ID field, which may be Boolean value indicating whether or not the software file has been modified since a previous verification. In certain embodiments, the modified software table 402 may include a respective software ID field and a respective software changed field for each software ID stored in the software table 372. Additionally, the modified software table 402 includes a test case cluster ID field 416 that is designed to store a value indicating a particular test case cluster of the test case cluster table 400 that is correlated with the changed software files indicated by the modified software table 402.

As mentioned, in other embodiments, the data model 370 and the TCP model 360 may be different. For example, in certain embodiments, various fields of the tables illustrated in FIG. 5 can be combined to form a single data source. By way of specific example, in certain embodiments, the TCP model 360 may include a single table, wherein the fields of the table include: a track name field that stores a name or identifier for the track associated with the set of software files being tested; a timestamp field that stores the time/date at which the software testing was performed; a test-name field that stores a name or identifier of a test case being applied; a changed_files_since_last_run field that stores a set of file names or identifiers indicating the files of the track that have been modified since a previous round of software testing; and a success-fail field that stores a Boolean value indicating a successful or a failed test result when applying the test case.

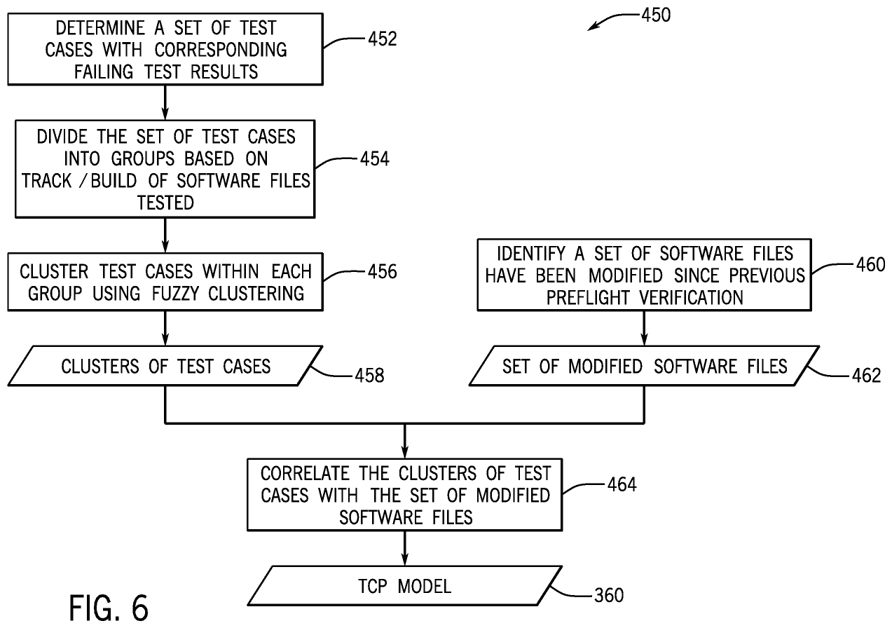

FIG. 6 is a flow diagram illustrating an embodiment of a process 450 whereby the TCP server 352 generates the TCP model 360 using the data stored in the software table 372, the test case table 374, and the test results table 376, as illustrated in FIG. 5. The process 450 is merely an example, and in other embodiments, the process 450 may include additional steps, fewer steps, repeated steps, and so forth, in accordance with the present disclosure. The illustrated process 450 may be stored in at least one suitable memory (e.g., memory 206) and executed by at least one suitable processor (e.g., processor 202) associated with the client instance 102 and/or the cloud-based platform 16. The process 450 is discussed with reference to elements in FIGS. 4 and 5.

It may be noted that, prior to executing the illustrated process 450, at least a portion of the software files 354 are executed according to at least a portion of the test cases 356 to produce a test results 358. For example, the test results 358 stored in the test results table 376 may be generated during a previous round of software testing, such as during a preflight verification of the software files 354 or during a final verification of the software files 354 before a merge. As such, it may be appreciated that the test results 358 may be generated at any time prior to performing the illustrated process 450. In general, each test result may be a success or a failure. As such, the illustrated embodiment of the process 450 begins with the TCP server 352 determining (block 452) a set of test cases having corresponding test results that indicate test failure. For example, the TCP server 352 may query a combination of the test results table 376 and the test case table 374 to identify all test cases that previously resulted in failing test results.

The illustrated process 450 continues with the TCP server 352 dividing (block 454) the set of test cases generated in block 452 into groups based on a track and/or build of each tested software file. For example, as discussed above, the software ID field 378, or another suitable field of the software table 372, may include track and/or build information for each software file. As such, the TCP server 352 may query the software table 372 to determine a track and/or build of each software file that corresponds to one of the set of test cases having an associated failing test result. It is presently recognized that grouping the test cases in this manner provides more meaningful correlations between the clusters of test cases and the modified software files in the completed TCP model 360.

The illustrated process 450 continues with clustering (block 456) test cases within each group of test cases generated in block 454 using fuzzy clustering to generate the clusters of test cases 458. Those skilled in the art will appreciate that fuzzy clustering (e.g., Fuzzy K-means) enables a test case to be part of multiple test case clusters. In certain embodiments, an unsupervised training method may be used to identify a set of test case clusters within each group of test cases to minimize the root mean square (RMS) error between clusters. As such, in certain embodiments, cluster generation may involve the use of a machine-learning (ML) component, such as an artificial neural network (ANN), support vector machines (SVM), a restricted Boltzmann machine, Bayesian networks, genetic algorithms, and the like. The actions of blocks 452, 454, and 456 generally correspond with the generation and population of the test case cluster table 400 of the TCP model 360.

The illustrated process 450 also involves the TCP server 352 identifying (block 460) a set of software files 462 that have been modified since the previous software testing. In some embodiments, identifying the set of modified software files 462 may include comparing two versions of a software file, such as a recent version of the software file and a previously validated version of the software file. In certain embodiments, to determine whether a software file has been modified, a comparison may be made between the value of the last modified field 382 of a software file listed in the software table 372 and the value of the timestamp field 396 of related test results in the test results table 376. For the embodiment illustrated in FIG. 5, identifying the set of modified software files may involve creating a new record in the modified software table 402, and for each software file that is determined to have been modified since the previous preflight verification, a Boolean value of true may be stored in the corresponding software changed field (e.g., software ID#1 changed field 412, software ID#2 changed field 414, etc.) of the modified software table 402. In certain embodiments, like the test cases, the set of modified software files may be grouped by track and/or build before proceeding to the next step.

The illustrated embodiment of the process 450 continues with the TCP server 352 correlating (block 464) the clusters of test cases 458 with the set of modified software files 462 to complete the TCP model 360. In certain embodiments, correlating may involve the use of a ML component, such as an ANN, a SVM, a restricted Boltzmann machine, Bayesian networks, a genetic algorithms, or another suitable ML component. For the embodiment illustrated in FIG. 5, correlating involves populating the test case cluster ID field 416 for the record of the modified software table 402 created in block 460, which establishes a relationship between certain clusters of test cases and certain groups of modified software files. It may be appreciated that software file changes that are associated with a test case cluster having a greater number of test cases may be considered “hot spots,” that include a number of features. As such, it is presently recognized that changes to these “hot spot” software files are more likely to result in a regression.

As discussed in further detail below, the TCP model 360 may be used for both preflight verification and before a merge of modified software files from multiple tracks. For example, during a quick preflight check, a software developer may desire relatively quick software testing using a minimal number of test cases to determine whether a recent change has introduced a regression. Additionally, prior to a software merge, the software developer may desire extensive software testing that provides a high level of confidence that the software modifications during development did not introduce any regressions.

As mentioned, the TCP model 360 may facilitate the accurate and efficient identification of regressions based on correlations between the changed software files 438 and the cluster of test cases 424. Once generated, different inputs may be provided to the TCP server 352, and the TCP server 352 can apply the TCP model 360 to generate different outputs that are useful during software development. For example, in certain embodiments, the TCP server 352 may receive a software file, a set of software files, and/or a test result of a test case as input. In response to the received input, the TCP server 352 may provide a suitable output, such as an indication of a likelihood of an error and/or test being a flapper, a minimum set of test cases, and the like, as discussed below.

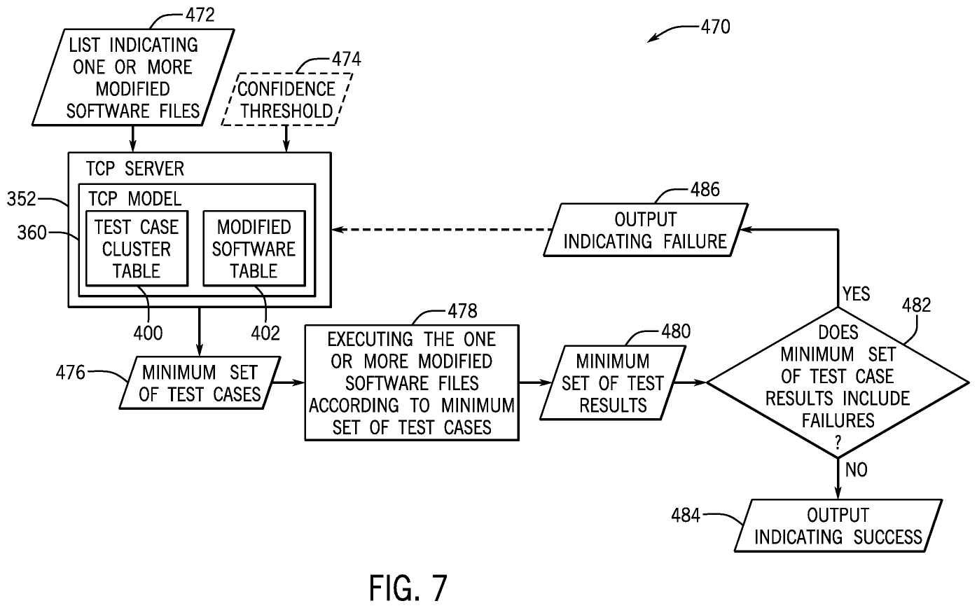

FIGS. 7-9 are flow diagrams illustrating example embodiments of processes whereby the TCP server 352 uses the TCP model 360 to facilitate different aspects of software development and testing. The processes are merely examples, and in other embodiments, the processes may include additional steps, fewer steps, repeated steps, and so forth, in accordance with the present disclosure. These processes may be stored in at least one suitable memory (e.g., memory 206) and executed by at least one suitable processor (e.g., processor 202) associated with the client instance 102 and/or the cloud-based platform 16. These processes are discussed with reference to elements illustrated in FIGS. 4 and 5.

FIG. 7 is a flow diagram illustrating an example embodiment of a process 470 whereby the TCP server 352 uses the TCP model 360 to determine a minimum set of test cases that would provide a minimal or basic assessment of whether or not a regression has been introduced in one or more software files modified since previous software testing (e.g., a previous preflight verification). The illustrated process 470 begins with the TCP server 352 receiving, as input, a list 472 indicating one or more software files (e.g., a list of software IDs) that have been modified since the previous software testing. In certain embodiments, the TCP server 352 may also receive a confidence threshold 474, which is a numerical value (e.g., between 1 and 100) indicating how thoroughly the TCP server 352 should test the software files for regressions. For such embodiments, the TCP server 352 will select a greater number of test cases to be applied to the modified software files for a larger confidence threshold 474. However, when a developer wants to maximize the efficiency of the preflight verification (e.g., reduce resource consumption, reduce wait time), the developer may provide a lower confidence threshold, which reduces the number of test cases applied to test the software files. In other embodiments, other constraints may be provided as inputs, such as a maximum run time constraint. As such, it may be appreciated that present embodiments enable the developer to have greater control over the time and resource costs associated with software testing. In certain embodiments, a default confidence threshold value (e.g., 90%) may be used when the confidence threshold 474 is not received by the TCP server 352.

In response to receiving these inputs, the TCP server 352 uses the TCP model 360 to identify a minimum set of test cases 476 that will determine whether or not regressions have been introduced into the modified software files indicated by the received list 472, in accordance with the confidence threshold 474. In an embodiment, the TCP server 352 may query the modified software table 402 for one or more records that correspond to one or more of the software files indicated by the list 472 being modified, and then determine one or more test case cluster IDs from the test case cluster ID field 416 from the returned data. For example, the TCP server 352 may locate a particular record in the modified software table 402 that reflects only the software IDs indicated by the list 472 being modified, and may use the test case cluster ID of that record to query the test case cluster table 400 and the test case table 374 to identify the minimum set of test cases. In another example, the TCP server 352 may locate a number of records in the modified software table 402 that reflect one or more of the software IDs indicated by the list 472 being modified, and may use the test case cluster IDs of those records to query the test case cluster table 400 and the test case table 374 to identify the minimum set of test cases 476. In another example, the TCP server 352 is unable to locate a record that that reflect one or more of the software IDs indicated by the list 472 being modified, and the TCP server 352 responds by querying the test case cluster table 400 for all test case cluster IDs, and then using these test case cluster IDs to query the test case cluster table 400 and the test case table 374 to identify the minimum set of test cases 476.

In certain embodiments, when the TCP server 352 queries the test case cluster table 400 and the test case table 374, the number of test cases that the TCP server 352 selects from each test case cluster may be based on the confidence threshold 474. For example, when the confidence threshold is relatively low (e.g., 50%), then the TCP server 352 may only select a single test case from each cluster of test cases, and when the confidence threshold is relatively high (e.g., 90%), then the TCP server 352 may select a multiple test cases from each cluster of test cases. In certain embodiments, the TCP server 352 may analyze the test results table 376 and preferentially select one or more test cases from each test case cluster based on propensity of the test cases to result in failures, based on an average runtime of the test cases, or other suitable factors.

The illustrated embodiment of the process 470 continues with the TCP server 352 executing (block 478) the one or more modified software files in accordance with the minimum set of test cases 476 to generate a minimum set of test results 480. Then, the TCP server 352 determines (decision block 482) whether the minimum set of test results 480 includes at least one failure. When the minimum set of test results 480 does not include a failure, the TCP server 352 provides an output 484 indicating successful preflight verification of the software files of the list 472. In certain embodiments, the output 484 may include a Boolean output indicating success, a list indicating the minimum set of test cases 476, a list indicating the minimum set of test results 480, the confidence threshold 474, a run time of the preflight verification, or a combination thereof

For the embodiment illustrated in FIG. 7, when the TCP server 352 determines (decision block 482) that the minimum set of test results 480 includes at least one failure, the TCP server 352 provides an output 486 indicating unsuccessful preflight verification of the software files indicated by the list 472. For such embodiments, this output 486 may include a Boolean output indicating failure, a list indicating the minimum set of test cases 476, a list indicating the minimum set of test results 480, the confidence threshold 474, a run time of the preflight verification, or a combination thereof. Additionally, in certain embodiments, the TCP server 352 may respond by using the failures from the minimum set of test results 480 and the TCP model 360 to identify additional test cases that should be applied to test the software files indicated by the list 472. In certain embodiments, a missing data model (e.g., a Restricted Boltzmann machine) may be used to identify additional test cases that should be applied based on the failing test results in the minimum set of test results 480. In an example embodiment, an initial failure of one test case of a test case cluster provides an indication that all test cases in the cluster should be applied. For such embodiments, the TCP server 352 may query the test case cluster table 400 and the test case table 374 to determine the test case cluster IDs associated with the test cases that yielded failing test results, and query the test case table 374 to select all test cases having these test case cluster IDs. Upon completion of these additional test cases, the TCP server 352 may provide an output 486 indicating information regarding which test cases resulted in failures, as discussed above.

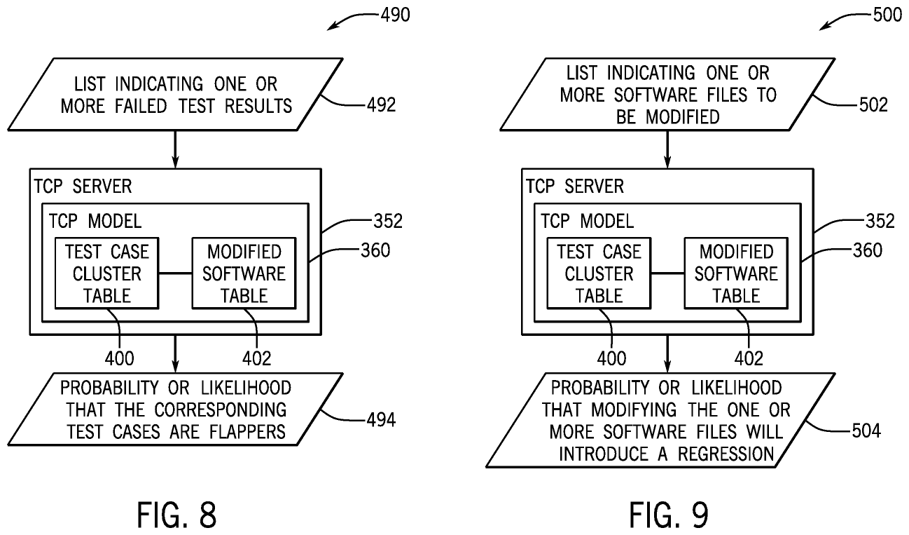

FIG. 8 is a flow diagram illustrating an example embodiment of a process 490 whereby the TCP server 352 determines a probability or a likelihood that a test case is a flapper. The illustrated embodiment of the process 490 begins with the TCP server 352 receiving, as input, a list 492 indicating one or more failed test results. To determine whether or not the test cases that correspond to the failed test results are flappers, the TCP server 352 may determine whether there is a logical correlation between software files being modified and the test cases resulting in failures. In an example, the list 492 may indicate a single failed test result (e.g., via a test case ID, a software ID, and a timestamp). The TCP server 352 may query the test results table 376 and the test case table 374 to determine the test case that corresponds to a failed test result in the list 492. The TCP server 352 may then query the modified software table 402, the software table 372, and the test results table 376 to select test results from software testing performed when software files had not been modified since it was previously tested. In certain embodiments, the TCP server 352 may also query these tables to select test results from software testing performed when software files had been modified since it was previously tested. The TCP server 352 may analyze the selected test results and calculate a probability or likelihood 494 that the test case that corresponds to the failed test result is a flapper. For example, in some embodiments, the probability or likelihood 494 that the test case is a flapper may be determined based on techniques such as an invariant detector or a chi-squared test. For embodiments in which the test result table 376 includes test results for at least full software verification (e.g., prior to a merge), a mixed effects model can be utilized to determine that the test case is a flapper when no predictive element is identified within the mixed effect model.

It is presently recognized that most test cases that are flappers have a failure rate that approaches 50% regardless of modifications to the software files. With this in mind, in one example embodiment, the TCP server 352 may calculate a failure rate of the test case from the selected test results when the software files had not been modified since a previous validation, and then calculate the probability or likelihood 494 that the test case is a flapper from this failure rate. For example, when a test case results in failure 25% of the time regardless of software file modification, then the TCP server 352 may determine that there is a 50% chance that the test case is a flapper. In another example, when a test case results in failure about 50% regardless of software file modification, then the TCP server 352 may determine that there is a 100% chance that the test case is a flapper. When the received list 492 indicates multiple failed test results, the TCP server 352 may repeat this process for each failed test result, and calculate a probability or likelihood 494 that each corresponding test case is a flapper. It may be appreciated that a similar strategy can be utilized to identify test cases that never fail, such that these test cases can be moved to a group that is only applied before a software merge, further reducing the amount of software testing performed between software merges.

FIG. 9 is a flow diagram illustrating an example embodiment of a process 500 whereby the TCP server 352 uses the TCP model 360 to determine a likelihood or probability that a planned software modification will introduce a regression. As shown in the illustrated embodiment of the process 500, a list 502 identifying one or more software files may be provided as an input to the TCP model 360, wherein the list 502 indicates software files that will be modified. For example, in an embodiment, the list 502 may include one or more software ID values that correspond to software files stored in the software table 372. In certain embodiments, the TCP server 352 may use the TCP model 360 and a maximum likelihood model with logistic regression to determine the probability or likelihood 504 that modifying the software files indicated in the list 502 will result in a regression.

For example, in an embodiment, the TCP server 352 may query the modified software table 402 to select test case cluster IDs for records in which the software files in the list 502 are indicated as being modified since a prior validation (e.g., in the software ID#1 changed field 412, the software ID#2 changed field 414, etc.). In certain embodiments, the TCP server 352 may determine how many test cases stored in the test case cluster table 400 correspond to the determined test case cluster IDs. In certain embodiments, the TCP server 352 may query the test case table 374 and the test results table 376 to select test results that correspond to the software files indicated in the list 502, and may analyze these test results to calculate a failure rate for the test cases or the test case cluster. In certain embodiments, based on the number of corresponding test cases and/or the calculated failure rate of the test cases, the TCP server 352 may calculate and output the probability or likelihood 504 that modifying the one or more software files in the list 502 will introduce a regression, based on the TCP model 360.

Technical effects of this disclosure include a substantial improvement in software testing. In particular, the disclosure techniques include generating a TCP model that correlates clusters of test cases and modified software files. Once the TCP model has been generated, the TCP model can be applied to provide useful information during software development and testing. For example, based on a set of modified software files, and the TCP model can be used to determine a probability or likelihood that a regression was introduced when the software files were modified. Additionally, based on set of modified software files, the TCP model may be used to determine a minimum set of test cases to be successfully passed to provide a reasonable likelihood that regressions have not been introduced when the software files were modified. The TCP model can also be used to determine a likelihood or probability that a failed test result is an indication of a regression or a flapper.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A Test Case Prioritization (TCP) system, comprising:
at least one memory configured to store software files and test cases; and
at least one processor configured to execute instructions stored in the at least one memory to cause the TCP system to perform operations comprising:
executing the software files according to the test cases to generate test results in the at least one memory, wherein each of the test results is associated with both a respective test case and a respective software file;
grouping and clustering the test cases into test case clusters;
identifying the software files that have been modified since a previous preflight verification; and
correlating the test case clusters with the modified software files to generate a Test Case Prioritization (TCP) model.

2. The TCP system of claim 1, wherein the software files and the test cases are stored in a database that is stored in the at least one memory.

3. The TCP system of claim 1, wherein grouping and clustering the test cases into test case clusters comprises:
grouping the test results by track, by build, or a combination thereof; and
providing the grouped test results to a machine-learning (ML)-based component of the TCP system, wherein the ML-based component is configured to cluster failed test results in the grouped test results to generate the test case clusters.

4. The TCP system of claim 3, wherein correlating the test case clusters with the modified software files comprises:
grouping the modified software files by track, by build, or a combination thereof; and
providing the grouped modified software files to the ML-based component of the TCP system, wherein the ML-based component is configured to correlate the test case clusters and the grouped modified software files to generate the TCP model.

5. The TCP system of claim 4, wherein the ML-based component is an artificial neural network (ANN).

6. The TCP system of claim 5, wherein the ANN comprises a restricted Boltzmann machine.

7. The TCP system of claim 1, wherein the at least one processor is configured to execute the instructions stored in the at least one memory to cause the TCP system to perform operations comprising:
providing, as input to the generated TCP model, one or more of the software files;
receiving, as output from the generated TCP model, a minimum set of the test cases to be applied to verify the one or more software files.

8. The TCP system of claim 7, wherein the minimum set of the test cases includes a respective test case from each test case cluster associated with each of the one or more software files.

9. The TCP system of claim 8, wherein the at least one processor is configured to execute the instructions stored in the at least one memory to cause the TCP system to perform operations comprising:
executing the one or more software files according to the minimum set of test cases to generate a minimum set of test results; and
in response to the minimum set of test results comprising only successes, providing an indication of a successful preflight verification.

10. The TCP system of claim 9, wherein the at least one processor is configured to execute the instructions stored in the at least one memory to cause the TCP system to perform operations comprising:
in response to the minimum set of test results comprising one or more failures:
providing the one or more failed test results as input to the generated TCP model; and
receiving, as output from the generated TCP model, a second set of the test cases to be applied to verify the one or more software files based on the one or more failed test results.

11. The TCP system of claim 1, wherein the at least one processor is configured to execute the instructions stored in the at least one memory to cause the TCP system to perform operations comprising:
providing one or more failed test results as input to the generated TCP model;
receiving, as output from the generated TCP model, one or more of the software files that are correlated with the one or more failed test results when the generated TCP model correlates the one or more failed test results with the one or more software files; and
receiving, as the output from the generated TCP model, an indication that the one or more failed test results are flappers when the generated TCP model does not correlate the one or more failed test results with the one or more software files.

12. The TCP system of claim 1, wherein the at least one processor is configured to execute the instructions stored in the at least one memory to cause the TCP system to perform operations comprising:
providing one of the software files as input to the generated TCP model;
receiving, as output from the generated TCP model, a value indicating a likelihood that modifying the software file will result in a regression based on a number of the test cases that are correlated with the modified software file in the generated TCP model.

13. A method of generating a Test Case Prioritization (TCP) model, comprising:
executing software files according to test cases to generate test results, wherein each of the test results is associated with both a respective test case and a respective software file;
grouping and clustering the test cases into test case clusters;
identifying the software files that have been modified since a previous preflight verification; and
correlating the test case clusters with the modified software files to generate the TCP model.

14. The method of claim 13, comprising:
retrieving a previous version of the software files from a memory of a database; and wherein identifying the software files that have been modified since the previous preflight verification is based on a comparison between the software files and the previous version of the software files.

15. The method of claim 13, wherein grouping and clustering the test cases into test case clusters comprises:
grouping the test results by track, by build, or a combination thereof; and
providing the grouped test results to a machine-learning (ML)-based component, wherein the ML-based component is configured to cluster failed test results in the grouped test results to generate the test case clusters.

16. The method of claim 13, comprising providing one or more failed test results as input to the generated TCP model;
receiving, as output from the generated TCP model, one or more of the software files that are correlated with the one or more failed test results when the generated TCP model correlates the one or more failed test results with the one or more software files; and
receiving, as the output from the generated TCP model, an indication that the one or more failed test results are flappers when the generated TCP model does not correlate the one or more failed test results with the one or more software files.

17. A tangible, non-transitory, machine-readable medium, comprising machine-readable instructions, wherein the machine-readable instructions, when executed by one or more processors cause the one or more processors to:
executing software files according to test cases to generate test results, wherein each of the test results is associated with both a respective test case and a respective software file;
grouping and clustering the test cases into test case clusters;
identifying the software files that have been modified since a previous preflight verification;
correlating the test case clusters with the modified software files to generate a Test Case Prioritization (TCP) model;
providing, as input to the generated TCP model, one or more of the software files; and
receiving an output from the generated TCP model.

18. The tangible, non-transitory, machine-readable medium of claim 17, wherein the output is a value indicating a likelihood that modifying the one or more software files will result in a regression based on a number of the test cases that are correlated with the modified software file in the generated TCP model.

19. The tangible, non-transitory, machine-readable medium of claim 18, wherein the output is a minimum set of the test cases to be applied to verify the one or more software files in a preflight verification.

20. The tangible, non-transitory, machine-readable medium of claim 18, wherein a number of test cases of the minimum set of the test cases is based on a confidence level input provided by a user.
